(19) United States
(12) Patent Application Publication
(10) Pub. No.: US 2013/0018752 A1
(43) Pub. Date: Jan. 17, 2013

(54) SYSTEM AND METHOD FOR REAL TIME AUCTION BIDDING

(71) Applicant: Shawn D. Foster, Lafayette, IN (US)

(72) Inventor: Shawn D. Foster, Lafayette, IN (US)

(21) Appl. No.: 13/548,514

(22) Filed: Jul. 13, 2012

Related U.S. Application Data
(60) Provisional application No. 61/507,333, filed on Jul. 13, 2011.

(51) Int. Cl. G06Q 30/08

(52) U.S. Cl. 705/26.3

(57) ABSTRACT

A vehicle auction bidding and valuation apparatus and method which employs a personal computing device to retrieve information related to a particular vehicle being auctioned and display potential profit information for the user in real time during the auction. When the user (typically a automobile dealer or reseller) selects a particular vehicle identification number or year, make and model, the personal computing device electronically retrieves valuation information for the vehicle and displays it for the user. The personal computing device may also be programmed with known business rules for various lenders or may retrieve the business rules information from one or more lender servers. The lender business rules are used to determine and display expected resale profits for the vehicle.

### CROSS REFERENCE TO RELATED APPLICATIONS

This application claims the benefit of U.S. Provisional Patent Application No. 61/507,333 filed Jul. 13, 2011, which is hereby incorporated by reference in its entirety.

### FIELD OF THE INVENTION

The present disclosure generally relates to vehicle trading and auction systems. More specifically, the present disclosure relates to a system and method for providing vehicle auction bidding and valuations in real time.

### BACKGROUND

In the automotive sales industry, retail dealers who wish to offer pre-owned vehicles for sale have two main options to acquire inventory. The first option is to acquire a customer's current vehicle as a “trade-in” toward the purchase of a vehicle in the dealer's existing inventory. The other option, and the most common, is for the dealer to purchase vehicles at an auction where large numbers of vehicles are offered for sale at wholesale prices. The wholesale prices are typically much less than the eventual retail price, allowing the dealer to realize a profit in certain cases. One problem for the dealer, however, is the variability of certain costs and other factors which are unknown when the dealer is deciding if and how much to bid for a given vehicle. For example, the “book value” may not be known to the dealer. Furthermore, various lending institutions have complicated formulas to determine the amount which the dealer may borrow to fund the purchase of the vehicle into inventory (or for sale to a prospective customer) and the fees associated with each loan. The lender fees and allowable borrowing amounts may also vary based on the particular vehicle. Because the time allotted for bidding on a given vehicle is typically less than a few minutes, it is very difficult for the dealer to determine how much to bid for the vehicle in order to ensure that a profit will be made when the vehicle is eventually sold to a retail customer.

### SUMMARY

According to one aspect, a vehicle auction bidding and valuation system is disclosed which employs a personal computing device to retrieve information related to a particular vehicle being auctioned and display potential profit information for the user in real time. When the user (typically an automobile dealer or reseller) selects a particular vehicle identification number or year, make and model, the personal computing device electronically retrieves valuation information for the vehicle and displays it for the user. The personal computing device 120 may also be programmed with known business rules for various lenders or may retrieve the lender business rules information from one or more lender servers. Using this information, the system displays a graphical interface which displays the current bid, the estimated vehicle value, and the expected potential profit for the user based on the lender business rules, the user business rules, and the current bid price. As the auction proceeds and the bid amount increases, the user is able to quickly determine the updated expected potential profit, thus helping to inform his purchasing decision.

According to another aspect, a computer-implemented method for providing expected resale profit information in a vehicle live auction setting is disclosed, comprising: receiving a description of a vehicle being auctioned, the description received using a processor of a personal computing device; using the processor, retrieving an estimated value for the vehicle from a vehicle valuation database; computing, using the processor, an expected retail price, the expected retail price based on said estimated value and a first lender business rule specific to a first lender; receiving a first auction bid price for the vehicle during the live auction using the personal computing device; computing, using the processor, a first expected profit for reselling the vehicle, the first expected profit based on the first auction bid price and the expected retail price; displaying the first expected profit value on an electronic display operatively connected to the personal computing device during the live auction; receiving a second auction bid price for the vehicle during the live auction using the personal computing device; computing, using the processor, a second expected profit value for reselling the vehicle, the second expected profit value based on the second auction bid price and the expected retail price; and displaying the second expected profit value on an electronic display operatively connected to the personal computing device during the live auction.

According to another aspect, an apparatus is disclosed comprising a memory; at least one processor; display; and an auction valuation application physically stored in the memory comprising computer-readable instructions, the computer-readable instructions, when executed by the at least one processor, cause the at least one processor to: receive a description of a vehicle being auctioned in a live auction; retrieve an estimated value for the vehicle from a vehicle valuation database; compute an expected retail price, the expected retail price based on said estimated value and a first lender business rule specific to a first lender; receive a first auction bid price for the vehicle during the live auction; compute a first expected profit for reselling the vehicle, the first expected profit based on the first auction bid price and the expected retail price; display the first expected profit value on the display during the live auction; receive a second auction bid price for the vehicle during the live auction; computing a second expected profit value for reselling the vehicle, the second expected profit value based on the second auction bid price and the expected retail price; and display the second expected profit value on an electronic display operatively connected to the personal computing device during the live auction.

According to another aspect, a computer-implemented method for providing expected resale profit information in a vehicle live auction setting, comprising: receiving a description of a vehicle being auctioned, the description received using a processor of a personal computing device; using the processor, retrieving an estimated value for the vehicle from a vehicle valuation database; receiving a first auction bid price for the vehicle during the live auction using the personal computing device; computing, using the processor, a first expected profit for reselling the vehicle, the first expected profit based on the first auction bid price, the estimated value, and a first lender business rule specific to a first lender; displaying the first expected profit value on an electronic display operatively connected to the personal computing device during the live auction; receiving a second auction bid price for the vehicle during the live auction using the personal computing device; computing, using the processor, a second expected profit value for reselling the vehicle, the second expected profit value based on the second auction bid price, the estimated value, and the first lender business rule; and displaying the second expected profit value on an electronic display operatively connected to the personal computing device during the live auction.

### BRIEF DESCRIPTION OF THE DRAWINGS

FIG. 1 is a diagrammatic view of a vehicle auction valuation system according to one implementation of the present disclosure.

FIG. 2 is an illustration of a sample screen display layout for a vehicle auction system according to one embodiment.

FIGS. 3A and 3B illustrate screen display layouts relating to adding and editing vehicle information according to one embodiment.

FIG. 4 is an illustration of screen display layouts relating to entering inventory information according to one embodiment.

FIG. 5 is an illustration of screen display layouts relating to system settings according to one embodiment.

FIG. 6 is a process flow diagram illustrating one set of steps performed in enabling a user to access valuation and estimated profit information using the novel system for a vehicle being auctioned.

FIG. 7 is a process flow diagram illustrating additional information relating to the process flow diagram of FIG. 2.

### DETAILED DESCRIPTION OF THE PREFERRED EMBODIMENTS

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

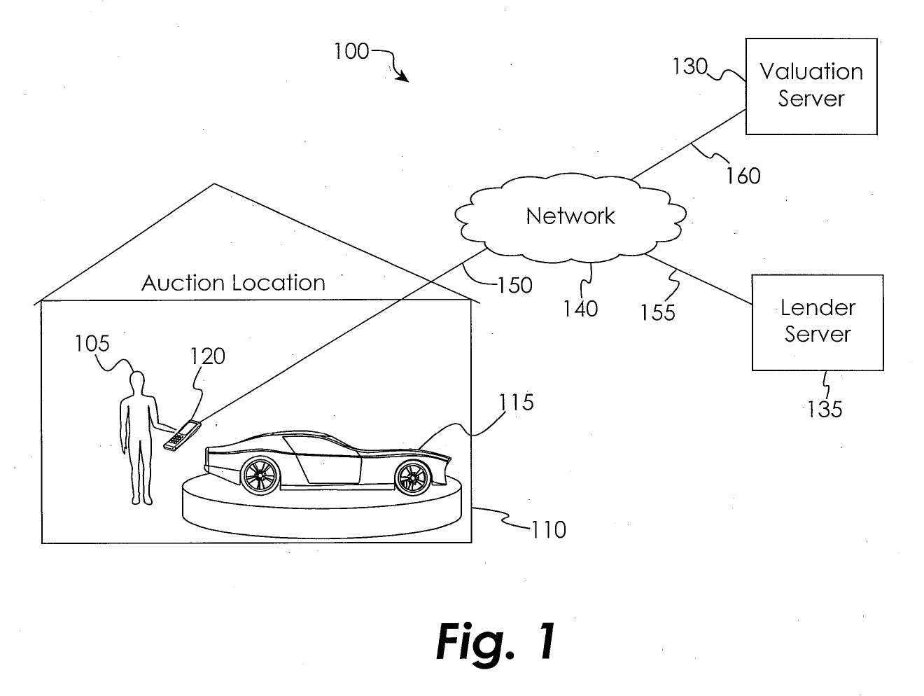

As shown in FIG. 1, one embodiment of a system 100 for providing valuation of vehicles in an auction in real time. The system 100 allows the user to quickly, and with increased confidence, determine whether the current bid for a vehicle at auction will allow the user to realize a desired profit margin upon resale. In the illustrated embodiment, the user 105 is located within a facility 110 where one or more vehicles 115 are being auctioned. As discussed above, the user 105 must make quick decisions regarding the bid amount as the vehicles 115 are being auctioned. In order to allow the user to determine if and how much to bid for a vehicle, a personal computing device 120 is provided for the user 105. The personal computing device 120 is in operative communication with one or more valuation servers 130 and/or one or more lender servers 135 via data network 140. The personal computing device is programmed with computer-readable instructions for providing a graphical user interface which receives input selections from and provides output information to the user regarding vehicle valuation and bid information. The user interface enables the user 105 to ascertain the vehicle book value, potential profit based on known lender business rules and/or user business rule, and other information needed by the user when determining whether (and what amount) to bid on a particular vehicle during the live auction.

The personal computing device 120 may comprise a cell phone, smart phone, or other mobile electronic device capable of wireless communication with servers 130 and 135 over network 140. For example, the personal computing device may comprise an iPhone®, iPad®, Blackberry®, or the like. In addition, the personal computing device 120 may include an electronic display, such as a liquid crystal display (LCD), and an input device, such as a physical keyboard or touchscreen incorporated into the display. The personal computing device 120 is preferably configured to run an application suitable for operation on various mobile operating systems including Microsoft Mobile, Google Android, Symbian OS, Palm OS, Mobile Linux, Apple OSX (iPhone, iPad), and MXI. In other forms, the application used by personal computing device 120 may be browser-based and/or include embedded software, to name a few non-limiting examples.

Each of the personal computing device 120 and servers 130 and 135 may utilize any processor and memory known in the art. For example, the processors may be of the electronic variety defining digital circuitry, analog circuitry, or both. In one embodiment, each processor is of a conventional, integrated circuit microprocessor arrangement, such as one or more CORE™ processors (including CORE 2 Duo, Core i3, Core i7 and the like) or PENTIUM 40 processors supplied by INTEL Corporation of 2200 Mission College Boulevard, Santa Clara, Calif. 95052, USA. It shall be appreciated that other processors manufactured by INTEL or other suppliers would be suitable for use with the system and method described herein.

Each memory of the personal computing device 120 and servers 130 and 135 may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties. The memory may also contain computer-readable instructions which are programmed or otherwise configured to direct the processor to perform the functionality of the system 100 as described herein.

Data network 140 can be in the form of a wireless or wired Local Area Network (LAN), Virtual Private Network (VPN), the internet, a cellular communication network, a combination of these, or other network arrangement as would occur to those skilled in the art. The operating logic of system 100 can be embodied in signals transmitted over network 140, in programming instructions, dedicated hardware, or a combination of these. It shall be understood that communication lines 150, 155 and 160 may comprise wireless or wired links between the various devices and network 140.

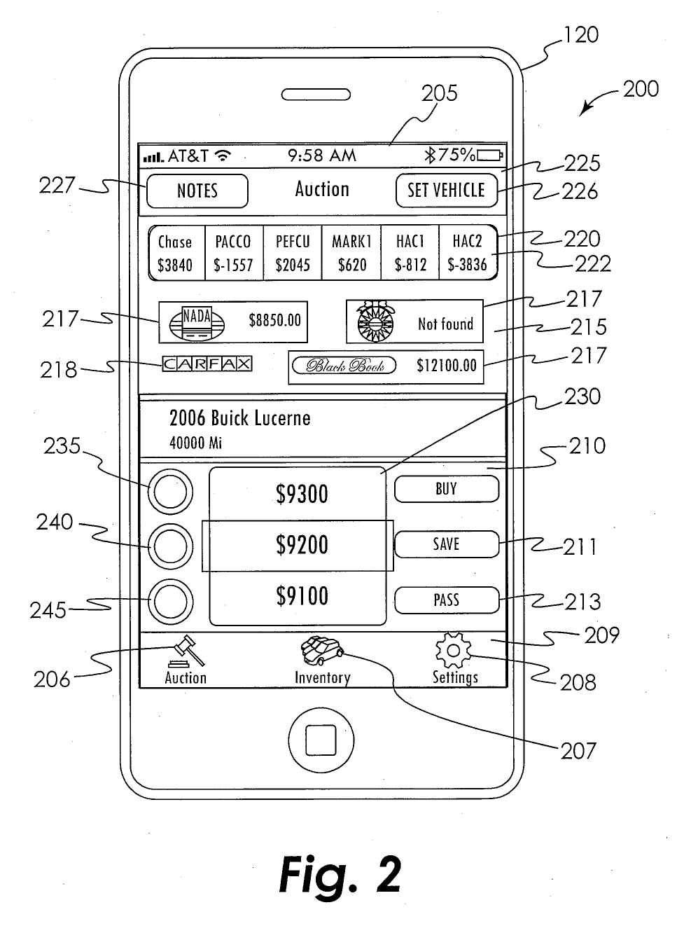

FIG. 2 illustrates a user interface 200 provided for operation within the personal computing device 120. Each screen of the interface 200 contains a lower navigation section 209 comprising navigation controls 206, 207, and 208. The controls 206, 207, and 209 allow the user to navigate to the three main tab screen layouts for “Auction” (205), “Inventory” (400), and “Settings” (500) respectively as described herein.

FIG. 2 also shows the “Auction” tab screen layout 205 of a user interface 200. As shown, the auction tab layout 205 includes an auction section 210, a valuation section 215, a lender section 220, and a vehicle selection section 225.

The auction section 225 may include a bid control 230, shown here as a simulated spinning dial with the middle value representing the currently selected amount. The bid control 230 allows the user to select the current bid for a vehicle by virtually “spinning” the dial with his finger until the desired bid is displayed. It shall be understood that other types of input controls may be utilized to implement the bid control 230 or other input and display controls on the interface 200. Based on the input bid amount and/or other criteria, one of the colored light indicators 235 (green), 240 (yellow), 245 (red) will be illuminated. In one embodiment, if the selected bid provides an expected profit margin above a previously-input desired value for at least one vendor, the green indicator 235 will illuminate. If the selected bid provides a profit margin which is below a desired value, yet still above zero, the yellow indicator 240 will illuminate. If the selected bid price results in a loss for the user, the red indicator 245 will be illuminated. This provides an intuitive indication to the user regarding whether a bid should be placed for the given amount. In other embodiments, the green indicator 235 will function as an aggregate profit indicator for multiple lenders; and will only illuminate if the desired profit will be achieved for a predetermined minimum number of lenders. In that case, the yellow light may be illuminated if the number of lenders resulting in a profit is at least one but less than the predetermined amount or if the predetermined amount of lenders result in a profit which is above zero but at least one of the lenders results in less than the desired profit. The profit estimation may also take into account various user business rules, such as required minimum down payment, estimated recondition cost estimates, documentation fees, sales tax, and the like. It shall be understood that other combinations of the above criteria or additional criteria may be used to determine the conditions required to illuminate the colored displays 235, 240, and 245.

The valuation section 215 includes indicator controls 217 which display vehicle book values for various valuation services, such as Black Book, National Automobile Dealers Association (NADA), and Kelly Blue Book. The values are electronically retrieved from the valuation servers 130 or from a vehicle value database stored within the memory of the personal computing device 120 and displayed in response to an input vehicle selection. The vehicle value database preferably contains a listing of common vehicles (make, model, year) and their estimated values, with variations in the value based on certain factors, such as mileage, condition, etc.). The indicator controls 217 may be optionally configured to activate a pop-up display of more detailed vehicle value information, such as separate vehicle values based on condition, type of sale (trade, retail, wholesale), and the like. Indicator control 218 may also be included which when activated, causes the personal computing device 120 to electronically retrieve and display information relating to the vehicle history from a predetermined reporting service, such as Carfax®.

The lender section 220 comprises controls 222 which indicate the lenders which the user typically employs to finance inventory purchases and/or finance retail customer sales. For each lender, a dollar amount is displayed by a control 222 which represents the expected profit or loss that will result for the user if that particular lender is used to finance the vehicle. The profit or loss is determined based on the specific business rules used by the lender and also optionally considering certain user business rules. For example, if a first lender charges a high rate of interest, restricts the principal loan amount on the vehicle to a relatively lower amount, and/or charges a relatively larger fee for financing the selected vehicle, the potential profit may be lower when that lender is used. Likewise, if another lender charges a lower rate of interest for the selected vehicle or is willing to allow a relatively larger principal loan amount for the selected vehicle, the potential profit may be higher. In a preferred embodiment, the background color of the controls 222 may also indicate if the resulting profit based on the particular lender business rule (and/or user business rules) is above or below a desired amount. For example, if the expected profit based on the lender is above a desired threshold, the background color of the control 222 will be green. If the expected profit is below the desired amount but above zero, the background color of the control 222 will be yellow. If the expected profit is negative, the background color of the control 222 will be red. If the selected vehicle does not qualify for financing by the lender (e.g., based on age, miles, or other factors considered in the lender business rules), the background of the control 222 for that lender may optionally be grayed out or otherwise indicated as not available. This provides the user with an intuitive indication of the potential for profit on a per-lender basis in real time as the auction is progressing. It shall be understood that other factors, fees, or considerations may be evaluated as part of the lender business rules or user business rules and are considered to be within the scope of the present disclosure.

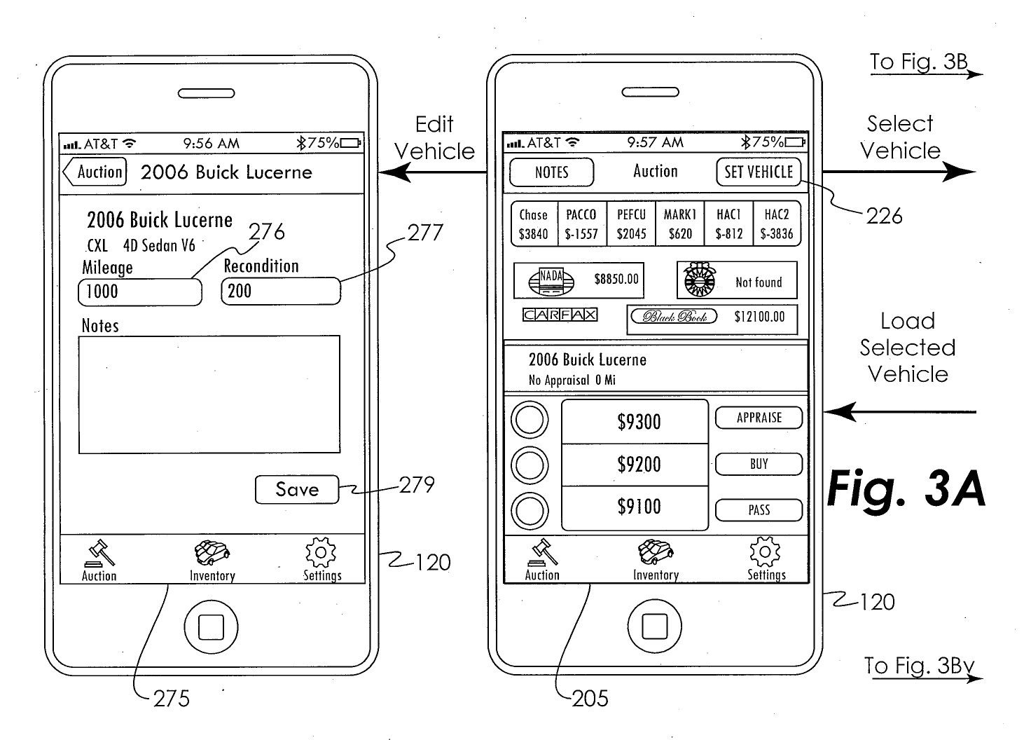

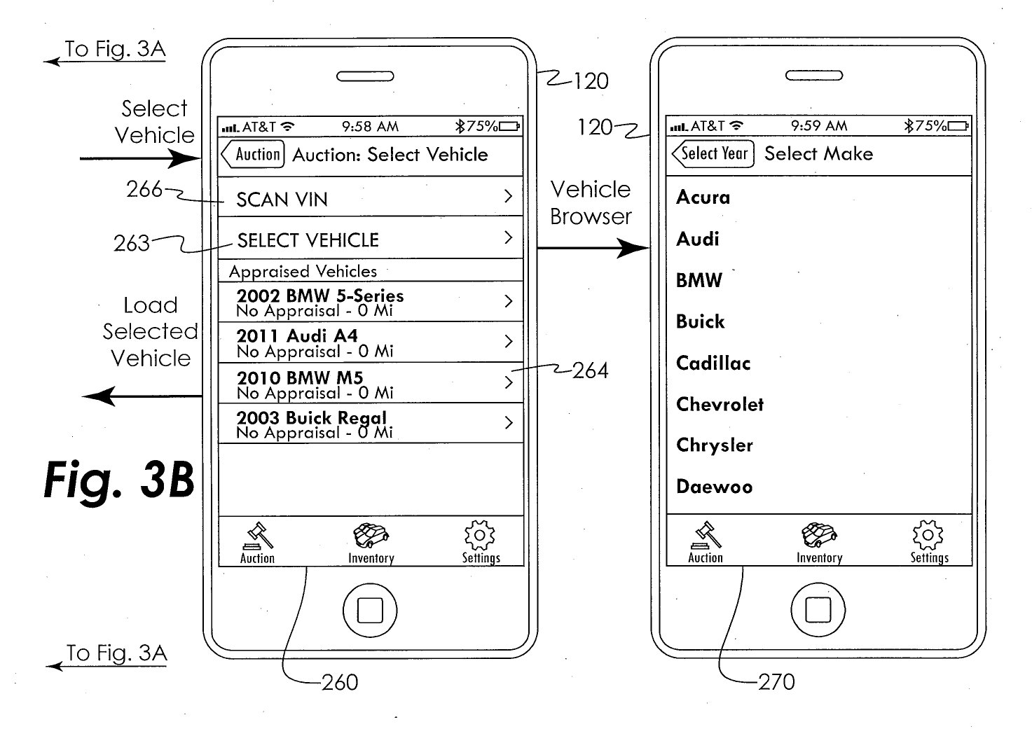

The vehicle selection section 225 includes controls 226, 227 for selecting a particular vehicle year, make and model, and/or editing an already selected vehicle description. As shown in FIGS. 3A and 3B, when the user activates the control 226, a “Select Vehicle” screen 260 will be displayed which allows the user to choose a vehicle for evaluation. By activating control 263 from the screen 260, the user may navigate through a series of screens, such as screen 270, which allow the user to input the vehicle make, model, year, and/or VIN of the vehicle to be evaluated. The screen 260 may also include controls 264 which display previously saved vehicles for quick selection.

In certain embodiments, the personal computing device 120 includes an optical scanner or camera which scans and determines the vehicle identification number (VIN) directly from the vehicle when the user activates the “Scan VIN” control 266 from screen 260. For example, the VIN may be displayed on a tag on the front dash of the vehicle or other common location. In addition to an optical scanner and/or camera, the personal computing device my employ character recognition software to interpret the scanned image of the VIN and record the value in the memory of the personal computing device 120. The VIN value may then be mapped to a particular vehicle year/make/model for use in determining the vehicle value and/or associated lender business rules.

If the user activates the “Edit Vehicle” control 227 on screen 205, a new screen 275 is displayed which allows the user to edit the mileage (via control 276), estimated reconditioning cost (via control 277), and other information about the vehicle, as well as record specific notes about the vehicle being evaluated. Control 279 is provided to save the edited information in memory for later retrieval.

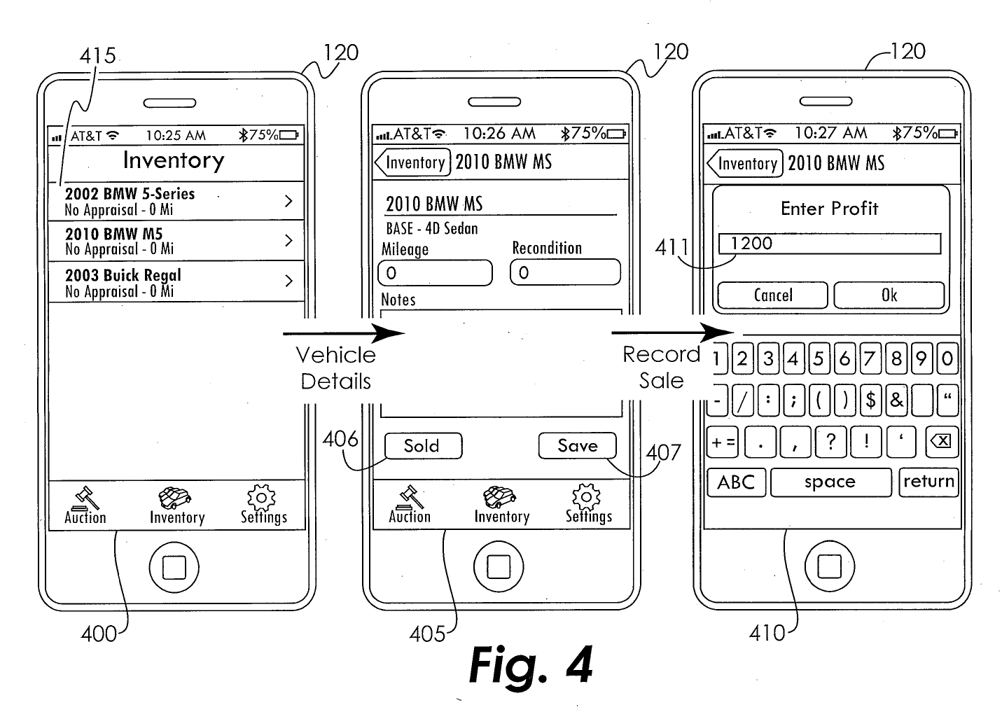

FIG. 4 illustrates interface screen layouts 400, 405, and 410 relating to inventory, that is, vehicles which have been purchased at auction. Accessible when the user activates control 207, screen 400 displays a list of the vehicles which the user has already purchased. When the user clicks or otherwise selects one of the vehicle indicator controls 415 for a specific vehicle, a vehicle detail screen 405 is displayed. Within screen 405, the user may modify the vehicle information (mileage, reconditioning cost, etc.) and save the vehicle information by activating control 407. When the user eventually sells the vehicle to a retail customer, he may activate control 406 and enter the realized profit within the screen 410 as shown. Once the realized profit is entered, the vehicle information may be removed from the inventory list and/or transferred to a list of sold vehicles in the memory of the personal computing device 120 or stored on a remote server.

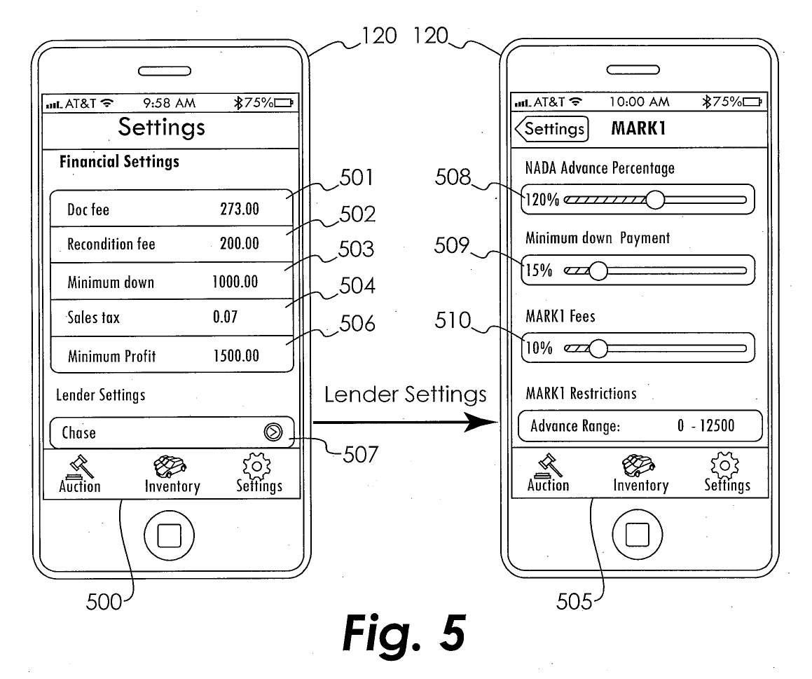

FIG. 5 illustrates interface screen layouts 500 and 505 relating to user settings. Screen layout 500 is displayed whenever the user activates control 208 as described above. As shown, screen 500 includes indicator controls for various user business rules relating to the overall auction event or general preferences of the user such as the required documentation fee (501), estimated reconditioning costs (502), minimum required down payment (503), sales tax rate (504), and minimum desired profit (506). Screen 505 (accessible by activating lender control 507) displays indicator controls relating to particular lenders business rules, such as advance percentage (508), minimum down payment (509), fees (510), and other restrictions.

It shall be understood that any of the displayed information in the various screen displays may be optionally selectable and adjustable by the user. For example, if the user clicks or otherwise activates or selects a display field or indicator control, a pop-up control may be presented which allows the user to manually type in a new value, incrementally increase or decrease a value, or select a value from a predetermined list.

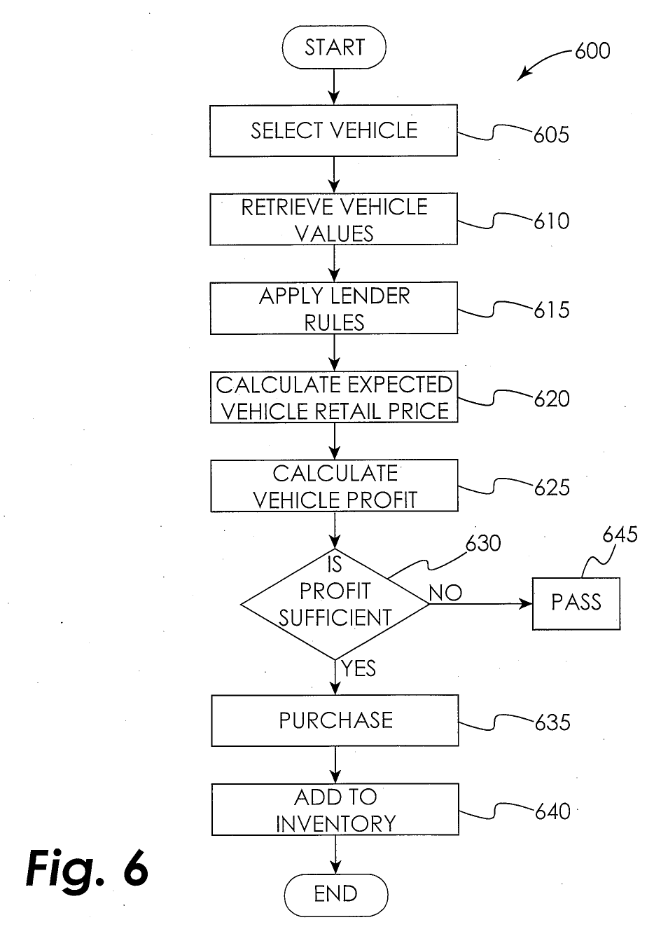

FIG. 6 illustrates a process 600 for enabling a user to access valuation information in real time using the system 100 for a vehicle being auctioned according to one embodiment. The process starts at step 605 when the user selects a vehicle which is being presented for auction. As described with respect to screens 260 and 270, the user may directly scan the vehicle YIN using the personal computing device and/or an attached optical scanner, or he may manually select or input the vehicle information. It shall be understood that the vehicle may be selected prior to or during the live auction.

Once the vehicle has been selected, the process continues at step 610 where the personal computing device 120 sends an electronic request containing the vehicle information to one of the valuation servers 130 via network 140. The valuation server 130 sends an electronic response to the personal computing device 120 containing an estimated book value for the vehicle. In certain embodiments, the book value may be retrieved from a vehicle value database stored in the memory of the personal computing device 120. The estimated value may be based on a variety of factors including, but not limited to, the selected year, make, model, mileage, condition, and/or type of retail environment where the vehicle will eventually be sold. The personal computing device 120 then displays the received value in the valuation section 215 of the screen 205 as described above. This step may be repeated for multiple valuation services, with the resulting valuations displayed concurrently on the personal computing device 120. If the user would like to save the vehicle appraisal information for future recall, he can click the “Appraise” button on screen 205 to have the vehicle added to a stored list of appraised vehicles.

At step 615, the system applies the business rules corresponding to the list of lenders to determine the potential profit based upon the currently selected bid amount. The lender business rules may be entered beforehand by the user via screens 500 and 505 or otherwise preprogrammed into the personal computing device 120, or electronically retrieved from the lender server 135. Based on the lender business rules, the system determines the maximum lending advance (loan principal) that the lender will authorize for the particular vehicle. For example, a particular lender may be willing to authorize a maximum lending advance equal to 130% of the NADA book value for the vehicle.

At step 620, the system calculates the maximum vehicle retail price which is expected in an eventual retail sale. For example, the maximum vehicle price may comprise the maximum advance from the lender, plus the minimum down payment, minus the dealer documentation fee. A reduction in the maximum retail price may also be made to account for sales tax, since many retail customers cannot pay the additional sales tax, and require a reduction in the price to account for the tax.

At step 625, the expected maximum profit is determined. The user selects the current auction bid price using the control 230 from screen 205. The system then calculates the maximum expected profit as the maximum vehicle price (based on the given lender), minus the reconditioning cost, minus the lender fees, minus the auction bid price. The maximum profit amounts, based on each of the lenders, are displayed for the user with associated color indications on screen 205 as described above. In this way, the user can easily predict the profit he will likely make on the vehicle for each lender. As the bid amount increases on the auction floor, the user can select a new bid amount using the control 230 and quickly see the revised expected profit amounts for each lender. In addition, the indicators 235, 240, and 245 provide a more simplified aggregate indication of likely profitability.

At block 630, the user determines whether the expected profit amount is sufficient to warrant a bid or purchase. If the profit is acceptable, he can place a bid in the live auction. After winning the auction, the user simply clicks the “Buy”control 210 on screen 205 to record the purchase price and add the vehicle to the inventory list at step 640. If the profit is not sufficient, the user can click the “Pass” control 213 on screen 205 to have the vehicle removed from the appraised list at step 645 and select a new vehicle for appraisal.

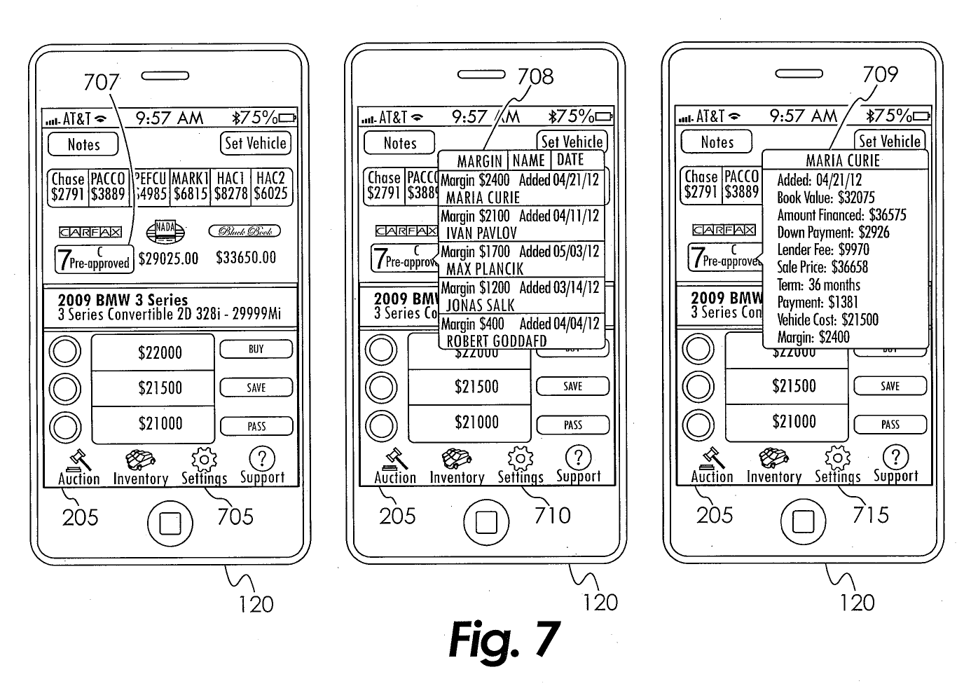

FIG. 7 illustrates a series of screenshots 705, 710, and 715 according to a further embodiment of the present disclosure wherein the screen 205 includes an indicator control 707 which provides an indication of how many customers have been preapproved for financing. The list of pre-approved customer records may be entered directly by the user or electronically retrieved from the lender servers 135. This allows a user to not only predict whether a profit is possible for a given vehicle for a given bid price and lender, but also whether he has a customer who is qualified to purchase the vehicle through the lender. In certain embodiments, the user can activate the control 707 to view a further pop-up display 708 which indicates the individual customer names and profit margins based on the lender that has qualified, each customer. By further activating one of the displayed records in the control 708, a further pop-up control 709 can be displayed which indicates further detailed information relating to a single customer. The displayed information may include, but is not limited to, date approved, vehicle book value, amount financed, down payment, lender fee, sale price, term, payment, vehicle auction bid price, and profit margin.

It shall be understood that in addition to vehicle auctions, the above-described methods and apparatus may be applied in a variety of live auction settings where the estimated “book value” of an item can be estimated based on valuation services for the type of item being auctioned or the expected profit for an item being purchased at auction for later resale is affected by lender business rules which may vary by lender. Examples of such live auction settings include, but are not limited to, heavy equipment, real estate, commodities trading, and the like.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed:

1. A computer-implemented method for providing expected resale profit information in a vehicle live auction setting, comprising:
receiving a description of a vehicle being auctioned, the description received using a processor of a personal computing device;
using the processor, retrieving an estimated value for the vehicle from a vehicle valuation database;
computing, using the processor, an expected retail price, the expected retail price based on said estimated value and a first lender business rule specific to a first lender;
receiving a first auction bid price for the vehicle during the live auction using the personal computing device;
computing, using the processor, a first expected profit for reselling the vehicle, the first expected profit based on the first auction bid price and the expected retail price;
displaying the first expected profit value on an electronic display operatively connected to the personal computing device during the live auction;
receiving a second auction bid price for the vehicle during the live auction using the personal computing device;
computing, using the processor, a second expected profit value for reselling the vehicle, the second expected profit value based on the second auction bid price and the expected retail price; and
displaying the second expected profit value on an electronic display operatively connected to the personal computing device during the live auction.

2. The method of claim 1,
wherein a plurality of expected retail prices are computed for a corresponding plurality of lenders; and
wherein a plurality of expected profit values are computed using the processor and concurrently displayed on the display during the live auction, each one of the plurality of expected profit values based on a corresponding one of the plurality of expected retail prices and the first auction bid price.

3. The method of claim 1,
wherein said estimated vehicle value is displayed concurrently with said first expected profit value on said display during the live auction.

4. The method of claim 1, further comprising:
providing a threshold profit indicator on the display concurrently with said first expected profit value; said threshold profit indicator indicating whether the first expected profit is above or below a threshold desired profit value.

5. The method of claim 1, wherein said threshold profit indicator is color based.

6. The method of claim 2, further comprising:
providing an aggregated profitability indicator, said aggregated profitability indicator based on whether a profit can be achieved using a predetermined number of lenders.

7. The method of claim 1, further comprising:
receiving a vehicle auction purchase selection using the personal computing device; and
storing the vehicle auction purchase selection in a purchased vehicle database;

8. The method of claim 7, wherein the purchased vehicle database is stored in the personal computing device.

9. The method of claim 8, wherein the purchased vehicle database is stored on a remote server.

10. The method of claim 1, wherein said lender business rules are stored on the personal computing device.

11. The method of claim 1, wherein said lender business rules are stored on a remote server.

12. The method of claim 7, further comprising:
receiving a vehicle retail sale selection using the personal computing device; and
storing profit information relating to the vehicle retail sale in a sold vehicle database.

13. The method of claim 1, further comprising:
retrieving a plurality of customer lending approval records for a plurality of retail customers; and
during the live auction, displaying an indicator indicating the number of approval records in said plurality of customer lending approval records.

14. The method of claim 1, wherein said expected retail price is further based on at least one user business rule.

15. An apparatus comprising:
a memory;
at least one processor;
a display; and
an auction valuation application physically stored in the memory comprising computer-readable instructions, the computer-readable instructions, when executed by the at least one processor, cause the at least one processor to:
receive a description of a vehicle being auctioned in a live auction;
retrieve an estimated value for the vehicle from a vehicle valuation database;
compute an expected retail price, the expected retail price based on said estimated value and a first lender business rule specific to a first lender;
receive a first auction bid price for the vehicle during the live auction;
compute a first expected profit for reselling the vehicle, the first expected profit based on the first auction bid price and the expected retail price;
display the first expected profit value on the display during the live auction;
receive a second auction bid price for the vehicle during the live auction;
computing a second expected profit value for reselling the vehicle, the second expected profit value based on the second auction bid price and the expected retail price; and
display the second expected profit value on an electronic display operatively connected to the personal computing device during the live auction.

16. The apparatus of claim 15,
wherein a plurality of expected retail prices are computed using the processor for a corresponding plurality of lenders; and
wherein a plurality of expected profit values are computed using the processor and concurrently displayed on the display during the live auction, each one of the plurality of expected profit values based on a corresponding one of the plurality of expected retail prices and the first auction bid price.

17. The apparatus of claim 15,
wherein said estimated vehicle value is displayed concurrently with said first expected profit value on said display during the live auction.

18. The apparatus of claim 15, wherein said expected retail price is further based on at least one user business rule.

19. The apparatus of claim 15, wherein a threshold profit indicator is provided on the display concurrently with said first expected profit value; said threshold profit indicator indicating whether the first expected profit is above or below a threshold desired profit value.

20. A computer-implemented method for providing expected resale profit information in a vehicle live auction setting, comprising:
receiving a description of a vehicle being auctioned, the description received using a processor of a personal computing device;
using the processor, retrieving an estimated value for the vehicle from a vehicle valuation database;
receiving a first auction bid price for the vehicle during the live auction using the personal computing device;
computing, using the processor, a first expected profit for reselling the vehicle, the first expected profit based on the first auction bid price, the estimated value, and a first lender business rule specific to a first lender;
displaying the first expected profit value on an electronic display operatively connected to the personal computing device during the live auction;
receiving a second auction bid price for the vehicle during the live auction using the personal computing device;
computing, using the processor, a second expected profit value for reselling the vehicle, the second expected profit value based on the second auction bid price, the estimated value, and the first lender business rule; and
displaying the second expected profit value on an electronic display operatively connected to the personal computing device during the live auction.
